(19) United States
(12) Patent Application Publication
(10) Pub. No.: US 2004/0049683 A1
(43) Pub. Date: Mar. 11, 2004

(54) Method and system for evaluation of sensitive data

(76) Inventor: Klaus Abraham-Fuchs, Erlangen (DE)

Correspondence Address: HARNESS, DICKEY & PIERCE, P.L.C., P.O.BOX 8910, RESTON, VA, 20195, US

(21) Appl. No.: 10/621,367

(22) Filed: Jul. 18, 2003

(30) Foreign Application Priority Data
Jul. 18, 2002 (DE) 10232678.9

(51) Int. Cl. H04L 9/00

(52) U.S. Cl. 713/182

(57) ABSTRACT

A method and a system are for evaluation of sensitive data, in which the sensitive data is stored in scrambled form. An evaluation module is provided for evaluation of the data and is for descrambling the scrambled data. One or more predetermined evaluation options are included, which can be inhibited or enabled in the evaluation module by an authorized person, to which expert rules are allocated for carrying out the evaluation. The evaluation options which are enabled by the authorized person are provided to a user for selection. After selection, the evaluation module carries out internal descrambling of the scrambled data and evaluation of the descrambled data in accordance with one or more expert rules which are associated with a selected evaluation option, and outputs the evaluation result without needing to make the descrambled data accessible outside the evaluation module. The method and the associated system allow sensitive patient data to be used by a doctor without needing to accept any risk of inadvertent disclosure of the individual data items.

The present application hereby claims priority under 35 U.S.C. §119 on German patent application number DE 10232678.9 filed Jul. 18, 2002, the entire contents of which are hereby incorporated herein by reference.

### FIELD OF THE INVENTION

The present invention generally relates to a method and to a system for evaluation of sensitive data, in particular medical data for patients. Preferably, by use of this method and system, the data can be used by authorized third parties without being directly available to them.

### BACKGROUND OF THE INVENTION

The handling of data that needs to be protected plays a major role in many fields. In the medical sector in particular, numerous sensitive data items occur, in particular medical data for patients, which must be protected in a particular manner against access by third parties. Data from the genome of a patient (DNA sequence data) may be mentioned as a particularly obvious and important example. On the one hand, medically very important information, such as the effectiveness of a specific medicament for this patient, about side effects of a medicament, about an existing predisposition for a specific debilitation, etc can be obtained from this data.

On the other hand, this data also contains highly confidential information which the patient may not wish to be accessible to others, for example by his medical insurance company, by his employee or by his relatives. Such confidential information may, for example, include the hereditary susceptibility to a debilitation, the presence of a debilitation which does not yet have any symptoms, etc. The patient is thus faced with the conflict as to whether he wishes to create DNA data himself and, for example, wishes to make it available for diagnosis purposes, although this involves the risk that this data could be misused for purposes which he had not agreed to, or whether he wishes to refuse the creation of the data, even though this restricts the capability to diagnose and treat debilitations.

WO 95/26006 discloses a method for providing information to a doctor about the health state of a patient. In this method, adverse effects on the health of a patient are organized in different categories, together with a classification of the seriousness of the adverse affect on health, in at least one examination. The classification is stored in the respective categories on a data storage medium. Access to the data may in this case be protected via an access key, which is stored on a smart card, possibly together with the classification data. The patient then takes this smart card to the respective doctor, who can call up the classification data with the permission of the patient, and can use it for his diagnosis or therapy decision.

U.S. Pat. No. 6,031,910 discloses a method and a system for secure transmission and storage of sensitive data, in which the data is stored in scrambled form. The key is stored on a smart card, so that the scrambled data can be used only when that smart card is used, possibly with an access authorization being entered.

However, in both situations, there is still a risk of access to the stored data. This is because it is impossible to prevent the possibility of at least some of the data that is made available being stored once again without protection by the respective person who is authorized to have access to it.

### SUMMARY OF THE INVENTION

An object of the present invention is to provide a method and a system for evaluation of sensitive data, in which access by third parties to the sensitive data is made considerably more difficult.

In the case of the present method, the sensitive data is scrambled and is stored in scrambled form, preferably without needing to make a key accessible for descrambling of the data. In fact, an evaluation module is provided, which contains means for descrambling the scrambled sensitive data and one or more predetermined evaluation options. The options can be inhibited or enabled in the evaluation module by an authorized person and expert rules can be allocated thereto for carrying out the evaluation, to which the evaluation module has access.

The authorized person is in this case the owner of the data, who has an interest in protection of the data and can control the capabilities to use it. As the recipient of the result of the evaluation module, the user is provided with the capability to select evaluation options which are enabled in the evaluation module. A selection by the user results in internal descrambling of the scrambled data, evaluation of the descrambled data in accordance with one or more expert rules which are associated with selected evaluation options, and the output of an evaluation result by the evaluation module. This is achieved without needing to make the internally descrambled data accessible to a user of the evaluation module. The expression expert rules in this case also includes mathematical evaluation algorithms.

In a corresponding manner, the associated system includes the evaluation module with an input and an output interface for the inputs by an authorized person or user, and the reading of data as well as the outputting of information about the enabled evaluation modules and the results of the respective evaluation. The evaluation module contains the means for descrambling the scrambled data as well as one or more predetermined evaluation options, which can be inhibited or enabled by an input by an authorized person. It also includes a device for internal descrambling of the scrambled data, for evaluation of the descrambled data in accordance with one or more expert rules, and for outputting the evaluation result via the output interface.

In one refinement of the present method, the sensitive data is stored in scrambled form, so that no-one can reproduce the original data or make it legible. This requires that no key be made accessible to anybody for descrambling and display of the scrambled data. In fact, with the present method, the scrambled data can be descrambled only by the evaluation module internally, without needing to make the descrambled data available externally. In another refinement of the method, the authorized person also has a key for descrambling the data.

The evaluation module also contains one or more predetermined evaluation options, which can be inhibited or enabled in the evaluation module by the authorized person and to which expert rules are allocated for carrying out the evaluation. The expert rules may in this case likewise be implemented in the evaluation module or stored outside the evaluation module, in which case the evaluation module must then, of course, have access to these expert rules when carrying out the method.

The predetermined evaluation options are preferably questions which are essential for producing a diagnosis or therapy. The associated expert rules in the simplest case can include conditions such as:

debilitation A is present when the conditions a, b and c are satisfied, or

medicament B is contraindicated when the conditions d and e are satisfied.

The conditions are in this case predetermined such that their satisfaction or non-satisfaction can be derived automatically from the scrambled patient data.

With the present method and the associated system, the user is provided with the capability to select from evaluation options which are enabled in the evaluation module. After selection of an appropriate evaluation option, for example a question relating to a contraindication, the evaluation module descrambles the necessary scrambled data internally using the possibly reconstructed key, which is available within the evaluation module. It then evaluates the descrambled data in accordance with the expert rules associated with the evaluation option. The evaluation result is then output to the user, for example in the form of an answer to the selected question.

In this way, the user is never provided with direct access to the descrambled individual data items. The desired confidentiality of the data is in fact ensured by the authorized person being able to inhibit or enable individual evaluation options or questions in order to make it possible to define which evaluation options are available for his data. The evaluation module then also supplies only the answer which is necessary for the medical decision, although the data which is required for derivation of the answer remains concealed from all those involved.

The descrambled data is thus never made directly accessible and can thus also not be stored at any other location by an authorized user of the system. Thus, it is possible to make confidential patient data available for diagnosis or therapy decisions, without the confidential data itself needing to be disclosed. A patient is therefore subject to a considerably lesser risk than in the past when, for example, he wishes to record data from his genome, and make it available for diagnosis purposes.

The device for descrambling the scrambled data which are contained in the evaluation module may directly include the key for descrambling the data, may include an algorithm for reconstruction of the key, etc. This algorithm produces the key in a known manner from data which can be predetermined, for example from the access authorization such as a password, from a fingerprint of the authorized person, etc., and operates in the same way as when the sensitive data was first stored in scrambled form.

With the present method and the associated system, not only is it possible to provide an evaluation module with two or more predetermined evaluation options, but it is also possible to provide two or more separate evaluation modules, which may also each cover only one evaluation option. In the latter case, the individual evaluation modules are enabled or inhibited in their entirety by the authorized person. For enabling, the key may in this case be stored in the respective evaluation module. However, it cannot be used directly by others since, on the one hand, the evaluation module can be activated or inhibited only by the authorized person and, on the other hand, only the result of an enabled evaluation is available.

In one particularly secure refinement of the present method, the sensitive data is scrambled immediately on being recorded or immediately after being recorded, so that it is never accessible on a data storage medium in unscrambled form. This refinement can be implemented in particular for automated recording or measurement of the data, for example for the recording of DNA sequence data.

In one particularly advantageous refinement of the present method and of the associated system, the authorized person, for example the patient, can enable evaluation options, and can load new enabled evaluation options into the evaluation module or system, at any desired time. He can thus ensure that the system is not configured to answer questions that are not approved by him, and is thus also not able to answer such questions. A user identification, for example a specific password, is, of course, checked for inhibiting and/or enabling and/or loading new enabled evaluation options, in order to prevent unauthorized persons from inhibiting and/or enabling evaluation options. The appropriate evaluation options can be enabled, inhibited or deleted, or new ones can be added, only by entering the correct user identification.

All the other interactive processes for the system, such as the storage of new data, the deletion of data, the selection of evaluation options and the reading of the evaluation results are preferably also provided with normal access protection, so that only users who are authorized for access can carry out the system functions. In this case, a list of the evaluation options which are enabled in the evaluation module is preferably displayed to the authorized user on a monitor, for interactive selection. After selection by the user, the evaluation module starts the evaluation activity in accordance with the expert rules which are associated with the evaluation option selected by the user, and preferably likewise outputs the evaluation result on the monitor.

The evaluation module itself may in this case be implemented either in hardware or as software. If it is implemented as software, this software can be stored in a data processing station or in a separate data storage medium, in order to be called up. By way of example, a smart card may also be used as the data storage medium.

If the evaluation module is implemented as software, the data may be descrambled in the processor of the respectively used data processing station. If the evaluation module is implemented in hardware, a smart card, for example, can be used with a processor implemented in it. In this case, the descrambling and evaluation of the data can be carried out exclusively on the smart card.

The scrambled patient data can also be stored at different locations. A smart card, a CD-ROM or other electronic data storage medium may likewise be used as examples of this. For example, this patient data can be stored in a databank, which is networked via a computer system. The evaluation module may in this case be located at a different point, provided that access is possible via a network to the databank with the scrambled patient data.

In one embodiment of the present method and system, both the evaluation module and the patient data are stored on the same data storage medium. If a portable data storage medium is used, this can be inserted into an interactive workstation, in order to allow a user or the authorized person to use the system and to inhibit or enable evaluation options. For example, a card reader can thus hold a smart card with the scrambled patient data and the evaluation module, and can allow the interactions via a connected computer. In principle, the scrambled patient data can also be stored and handled independently of the evaluation module. However, the data can be descrambled only by the evaluation module.

The expert rules can be stored together with the evaluation module, or may be contained in a separate databank. Maintenance of the expert rules in a separate databank to which the evaluation module has access as required makes it easier to replace individual expert rules or the entire databank by more recent versions, in which the conditions of the expert rules correspond to the latest scientific knowledge. Much of the relevant patient data, in particular DNA sequence data, may be created only once in the patient's life, and remains valid throughout the entire life of the patient. In contrast, knowledge about the medical validity of the data is growing continuously, so that continuously improved or new laws should be used. This is advantageously made possible by central storage in the expert rules.

The present method and the associated system may, of course, be used not only for genetic data but also for other patient data. It is thus possible, for example, for there to be contraindication for a specific medicament, for example, for a number of debilitations or states, for example pregnancy. The expert rules are in this case designed such that they take account of all possible debilitations or states which lead to the contraindication, and check the descrambled patient data for the presence of these conditions or debilitations. In this case, however, the system then outputs only an answer as to whether the corresponding medicament is or is not contraindicated. The reason for contraindication remains unknown and confidential.

Although the present method and the associated system have been explained in the present description and in the following exemplary embodiments with reference to medical data, it is obvious to those skilled in the art that the method and the system can also be used in the same way for evaluation of other sensitive data, in which case the individual data items should not be accessible to anyone.

### BRIEF DESCRIPTION OF THE DRAWINGS

The present method and the associated system will be explained once again briefly in the following text with reference to exemplary embodiments and in conjunction with the drawings, in which:

FIG. 1 shows a first example for carrying out the method;

FIG. 2 shows a second example for carrying out the method; and

FIG. 3 shows an example of the implementation and use of the system in the form of a smart card.

### DETAILED DESCRIPTION OF THE PREFERRED EMBODIMENTS

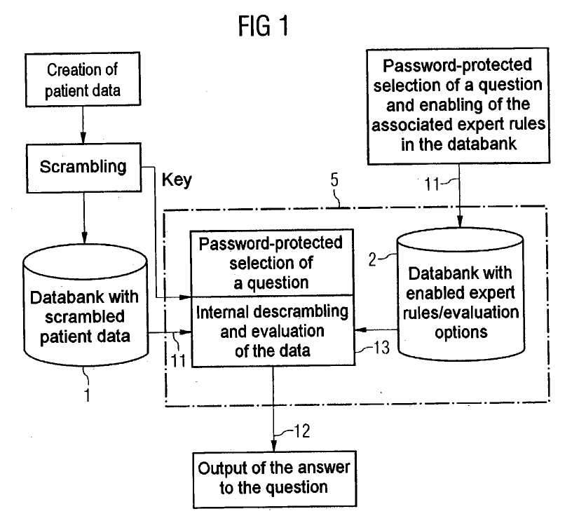

FIG. 1 shows a first example of the present method being carried out on the basis of the recording and evaluation of medical patient data. In a first step of the method, the patient data, for example DNA sequence data, is created and is scrambled immediately before being stored. The key which is required for descrambling the data is stored in an evaluation module 5 such that it is not accessible to anyone. The scrambled data is stored in a databank 1 which, for example, may be formed on a smart card, on a hard disk of a computer system or on any other electronic data storage medium. This scrambled patient data may admittedly be copied and disseminated as required, but cannot be descrambled, and hence read, by anyone, since it is in a scrambled form.

The evaluation module, whose only capability is to internally descramble the scrambled data on the basis of the implemented key, contains one or more evaluation options, which are in the form of questions and are stored in a databank in the system. The individual evaluation options can be enabled or inhibited by the authorized person, in the present case the patient, after entering an appropriate access code. The evaluation options and questions are linked to expert rules which, in the present example, are stored in the same databank 2 and are provided with the necessary checking instructions for checking specific conditions in the scrambled patient data, on the basis of which the selected question can be answered. For the authorized person to inhibit or enable individual questions, it is also, of course, possible for these questions to be enabled or to be inhibited indirectly by enabling or inhibiting the expert rules linked to them.

One example of a question which can be enabled by the patient could, for example, be: Is medicament B contraindicated? If this question is enabled in the evaluation module by the authorized person and if it is selected by the user of the system, for example a doctor carrying out a treatment, then the evaluation module checks the internally descrambled data in accordance with the expert rule which is linked to this question. This expert rule may, for example, be: Medicament B is contraindicated when conditions a and be are satisfied. The evaluation module then checks the descrambled patient data for the presence of the conditions a and b. If this check is positive, that is to say the conditions a and b are satisfied in the patient data, then the evaluation module outputs the answer: Medicament B is contraindicated. Further data, in particular details from the descrambled patient data, are not exposed to the user.

The questions which can be selected by the user, that is to say the enabled questions, are preferably displayed to him on a monitor at his computer workstation. The enabled questions are in this case read from the evaluation module, and/or are output from the evaluation module. The user can then mark or activate the question that he wishes to ask on his monitor, and can transmit it to the evaluation module by means of an input. In this case, it is irrelevant whether the patient data is stored in a portable data storage medium which is read at the data processing station of the user or is stored in a central databank, to which the user has access via a network. In order to evaluate the data, the evaluation module retrieves the scrambled data via the appropriate connection, and evaluates it. In this case, the data never exists in unscrambled form outside the evaluation module 5 or the processor of the computer that is used.

The only authorized person in the present case, the patient, can enable further already predetermined questions or can load and enable additional questions into the evaluation module by way of an appropriate access authorization, which is protected by an access code, in the evaluation module 5. In this way, the area within which the sensitive data is used can be widened or restricted at any time by the authorized person. The area of use of the data cannot be changed by anyone else who does not possess the appropriate identification feature, for example an access code or the registered fingerprint.

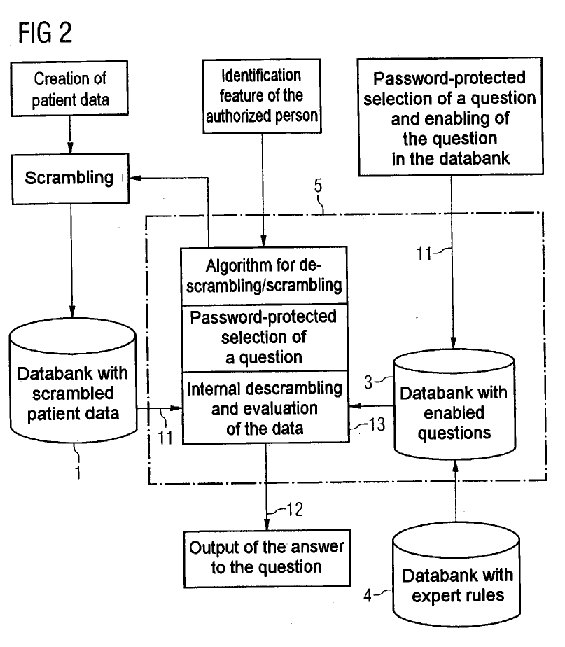

FIG. 2 shows a further example for carrying out the present method, which in many ways is carried out in the same way as already explained in conjunction with FIG. 1. In contrast to the exemplary embodiment in FIG. 1, the patient data is in this example scrambled by use of an algorithm that is stored in the evaluation module 5 and which scrambles the data as a function of an input by the only authorized person, the patient. No key for descrambling the data is stored in this case. In fact, the descrambling of the data can be carried out by using the same algorithm, once the appropriate identification feature for the authorized person has been entered. The key for descrambling the data is thus in each case reconstructed as required in the evaluation module 5.

In the present example, the individual questions are also stored separately from the associated expert rules. The questions, which may be enabled or inhibited by the authorized person, are a component of the evaluation module 5 in a databank 3, while the associated expert rules are stored in a separate central databank 4. When used via a network, the evaluation module 5 has access to this databank 4 with the expert rules.

Central storage of the expert rules has the advantage that they can be maintained in a simple manner, and, in particular, they can be matched to more recent scientific knowledge in a simple manner. In particular, this allows a large number of evaluation modules for different patients each to access the same databank 4 with expert rules. The expert rules need be updated at only one point.

The enabling and inhibiting are in this case carried out, of course, within the respective evaluation modules, with the individual questions being inhibited and enabled directly in this case. With the present method, the questions are, of course, selected together with the associated expert rules such that it is not possible to deduce individual entries in the patient data from a single question.

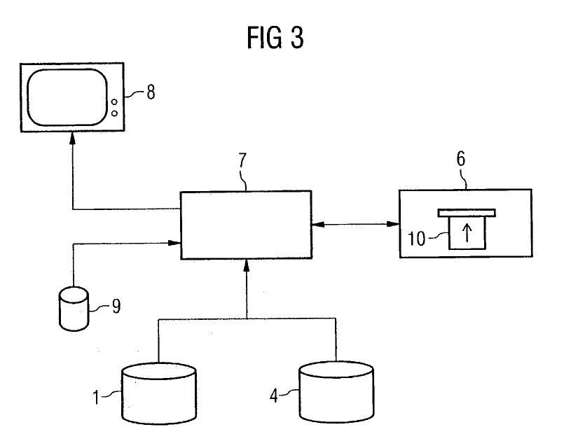

Finally, FIG. 3 shows an example of the use of the present method and of the associated system with a conventional data processing station, which can be connected to other computers or databanks via a network. This data processing station 7 may, for example, be the computer workstation of the respective doctor carrying out the treatment, and is equipped with a monitor 8 and an input unit 9. In the present example, the patient data is stored in scrambled form in a central databank 1, which the data processing station 7 of the doctor can access via a network, such as the Internet.

The evaluation module 5 is implemented on a smart card 10 which contains the individual enabled questions. In this case, the doctor must have a reader 6 for this smart card 10. Once the smart card 10 has been inserted into the reader 6, a list of the available enabled questions is displayed on the screen 8 to the doctor, and he can use the input unit 9 to select a question from this list. After selection of the question, the evaluation module 5 uses the network to retrieve the associated expert rules from a central databank 4, and the scrambled data from the databank 1.

The evaluation module descrambles the data internally using a microprocessor that is implemented, and evaluates this data in accordance with the expert rules that have been loaded. The evaluation result is then transmitted to the data processing station 7, and is displayed on the screen 8. If no dedicated processor is implemented on the smart card 10, then in this case the processor of the data processing station 7 may also be used to load the software for descrambling and evaluation of the data by the evaluation module 5.

The present system and the associated method allow confidential patient data to be used for the purpose of subsequent diagnosis or therapy decisions, without needing to make this data directly available to anyone. The scrambled stored data is evaluated by one or more evaluation modules, and the answer to the selected question, which has been enabled by the authorized person, is output to the user without the data being visible in descrambled form to any of those involved. This reduces the risk of inadvertent disclosure of the data, and improves the capability of the doctor carrying out the treatment to plan his diagnosis and therapy.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for evaluating of sensitive data, comprising:
provisioning an evaluation module for descrambling scrambled and stored sensitive data, including at least one predetermined evaluation option which is at least one of inhibitable and enableable in the evaluation module by an authorized person and to which expert rules are allocated for carrying out an evaluation process, to which the evaluation module has access;
selecting an option from evaluation options enabled in the evaluation module for a user; and
internally descrambling the scrambled data, evaluating the descrambled data in accordance with at least one expert rule associated with the selected evaluation option, and outputting an evaluation result using the evaluation module, without making the descrambled data accessible during the evaluation process.

2. The method as claimed in claim 1, wherein the evaluation module includes at least one of a key and an algorithm for reconstruction of a key for descrambling the scrambled data.

3. The method as claimed in claim 2, wherein the algorithm produces the key as a function of at least one of an input and of a biometric feature of the authorized person.

4. The method as claimed in claim 1, wherein the sensitive data is scrambled immediately after its recording, so that it is not accessible in unscrambled form on a data storage medium.

5. The method as claimed in claim 1, wherein the expert rules are implemented in the evaluation module.

6. The method as claimed in claim 1, wherein the expert rules are stored in a databank, to which the evaluation module has access while carrying out the method.

7. The method as claimed in claim 1, wherein the at least one of inhibiting and enabling of evaluation options in the evaluation module is permitted only after the authorized person has entered a predetermined user identification.

8. The method as claimed in claim 7, wherein, after entering the predetermined user identification in the evaluation module, the authorized person is enabled to at least one of add further evaluation options and delete evaluation options.

9. The method as claimed in claim 1, wherein a selection option, from the evaluation options enabled in the evaluation module, is provided by displaying a list of the enabled evaluation options on a monitor.

10. The method as claimed in claim 1, wherein the data is evaluated by the evaluation module only after a predetermined access code has been entered.

11. The method as claimed in claim 1, wherein the scrambled data and the evaluation module are stored on a common data storage medium.

12. The method as claimed in claim 1, wherein the scrambled data and the evaluation module are stored on separate data storage media.

13. The method as claimed in claim 1, wherein at least one of the scrambled data and the evaluation module is stored on a portable data storage medium.

14. The method as claimed in claim 1, wherein the evaluation options include questions.

15. The method as claimed in claim 1, wherein the evaluation options are selected using the associated expert rules such that they do not allow any conclusion to be drawn from the evaluation result relating to individual sensitive data items.

16. The method as claimed in claim 1, wherein the authorized person is provided with a means for descrambling the scrambled data.

17. A system for evaluating sensitive data, comprising:
an input interface;
an output interface; and
an evaluation module for descrambling scrambled data, including at least one predetermined evaluation option which is at least one of inhibitable and enableable in the evaluation module by an authorized person and to which expert rules are allocated for carrying out the evaluation, to which the evaluation module has access, the evaluation module adapted to internally descramble the scrambled data, evaluate the descrambled data in accordance with at least one expert rule associated with a selected evaluation option, and output an evaluation result via the output interface.

18. The system as claimed in claim 17, wherein evaluation module includes at least one of a key and an algorithm for reconstruction of a key.

19. The system as claimed in claim 18, wherein the algorithm produces the key as a function of at lest one of an input and a biometric feature of the authorized person.

20. The system as claimed in claim 17, wherein the expert rules are implemented in the evaluation module.

21. The system as claimed in claim 17, wherein the expert rules are stored in a databank, to which the evaluation module has access while carrying out the method.

22. The system as claimed in claim 17, wherein the evaluation module is designed such that it allows evaluation options to be at least one of inhibited and enabled only after entering a predetermined user identification.

23. The system as claimed in claim 22, wherein the evaluation module is designed such that further evaluation options can be at least one of added and deleted, after entering the predetermined user identification.

24. The method as claimed in claim 17, wherein the evaluation module is designed to display enabled evaluation options on a monitor.

25. The method as claimed in claim 17, wherein the evaluation module is designed such that it evaluates the data only after a predetermined access code has been entered.

26. The method as claimed in claim 17, wherein the scrambled data and the evaluation module are stored on a common data storage medium.

27. The method as claimed in claim 17, wherein the scrambled data and the evaluation module are stored on separate data storage media.

28. The method as claimed in claim 17, wherein at least one of the scrambled data and the evaluation module is stored on a portable data storage medium.

29. The method as claimed in claim 17, wherein the evaluation options are questions.

30. The method as claimed in claim 2, wherein the sensitive data is scrambled immediately after its recording, so that it is not accessible in unscrambled form on a data storage medium.

31. The method as claimed in claim 3, wherein the sensitive data is scrambled immediately after its recording, so that it is not accessible in unscrambled form on a data storage medium.

32. A method for evaluating sensitive data using an evaluation module, adapted to descrambling scrambled and stored sensitive data, including at least one evaluation option which is at least one of inhibitable and enableable in the evaluation module by an authorized person and to which expert rules are allocated for carrying out an evaluation process, the method comprising:
selecting an option from evaluation options enabled in the evaluation module for a user; and
internally descrambling the scrambled data, evaluating the descrambled data in accordance with at least one expert rule associated with the selected evaluation option, and outputting an evaluation result using the evaluation module, without making the descrambled data accessible during the evaluation process.

33. The method as claimed in claim 32, wherein the evaluation module includes at least one of a key and an algorithm for reconstruction of a key for descrambling the scrambled data.

34. The method as claimed in claim 33, wherein the algorithm produces the key as a function of at least one of an input and of a biometric feature of the authorized person.

35. The method as claimed in claim 32, wherein the sensitive data is scrambled immediately after its recording, so that it is not accessible in unscrambled form on a data storage medium.

36. The method as claimed in claim 32, wherein the at least one of inhibiting and enabling of evaluation options in the evaluation module is permitted only after the authorized person has entered a predetermined user identification.

37. The method as claimed in claim 36 wherein, after entering the predetermined user identification in the evaluation module, the authorized person is enabled to at least one of add further evaluation options and delete evaluation options.

38. The method as claimed in claim 32, wherein a selection option, from the evaluation options enabled in the evaluation module, is provided by displaying a list of the enabled evaluation options on a monitor.

39. The method as claimed in claim 32, wherein the scrambled data and the evaluation module are stored on a common data storage medium.

40. The method as claimed in claim 32, wherein the scrambled data and the evaluation module are stored on separate data storage media.

41. The method as claimed in claim 32, wherein at least one of the scrambled data and the evaluation module is stored on a portable data storage medium.

42. An evaluation module for descrambling scrambled data, including:
at least one predetermined evaluation option which is at least one of inhibitable and enableable in the evaluation module by an authorized person and to which expert rules are allocated for carrying out the evaluation, to which the evaluation module has access; and
means for internally descrambling the scrambled data, evaluating the descrambled data in accordance with at least one expert rule associated with a selected evaluation option, and outputting an evaluation result via the output interface.

43. The module as claimed in claim 42, wherein evaluation module includes at least one of a key and an algorithm for reconstruction of a key.

44. The module as claimed in claim 43, wherein the algorithm produces the key as a function of at lest one of an input and a biometric feature of the authorized person.

45. The module as claimed in claim 42, wherein the expert rules are implemented in the evaluation module.

46. The module as claimed in claim 42, wherein the expert rules are stored in a databank, to which the evaluation module has access while carrying out the method.

47. The system as claimed in claim 42, wherein the evaluation module is designed such that it allows evaluation options to be at least one of inhibited and enabled only after entering a predetermined user identification.

48. The module as claimed in claim 47, wherein the evaluation module is designed such that further evaluation options can be at least one of added and deleted, after entering the predetermined user identification.

49. The module as claimed in claim 42, wherein the evaluation module further is adapted to display enabled evaluation options on a monitor.

50. The module as claimed in claim 42, wherein the evaluation module is designed such that it evaluates the data only after a predetermined access code has been entered.

51. The module as claimed in claim 42, wherein the evaluation module is stored on a common data storage medium with the scrambled data.

52. The module as claimed in claim 42, wherein the evaluation module and the scrambled data are stored on separate data storage media.

53. The module as claimed in claim 42, wherein at least one of the scrambled data and the evaluation module is stored on a portable data storage medium.
